(19) United States
(12) Patent Application Publication
(10) Pub. No.: US 2015/0219515 A1
(43) Pub. Date: Aug. 6, 2015

(54) PHYSICAL QUANTITY SENSOR, ALTIMETER, ELECTRONIC APPARATUS, AND MOVING OBJECT

(71) Applicant: Seiko Epson Corporation, Tokyo (JP)

(72) Inventor: Kazuya HAYASHI, Suwa (JP)

(21) Appl. No.: 14/609,781

(22) Filed: Jan. 30, 2015

(30) Foreign Application Priority Data
Jan. 31, 2014 (JP) 2014-016647

(51) Int. Cl. G01L 19/08

(52) U.S. Cl. CPC G01L 19/08

(57) ABSTRACT

A physical quantity sensor includes a substrate having a diaphragm, a sensor element disposed on the diaphragm, a wall section disposed on the substrate, and having a hollow section surrounding the sensor element, a covering section connected to the wall section, and a reinforcement section disposed so as to partially overlap the covering section, and including a material lower in thermal expansion coefficient than a constituent material of the covering section.

### BACKGROUND

1. Technical Field

The present invention relates to a physical quantity sensor, an altimeter, an electronic apparatus, and a moving object.

2. Related Art

For example, it is possible to apply an MEMS vibrator described in JP-A-9-126920 to a pressure sensor. Ina detailed explanation, the MEMS vibrator of JP-A-9-126920 includes a substrate, a vibrator element disposed on the upper surface of the substrate, and a peripheral structure surrounding the vibrator element, and by forming the part of the substrate where the vibrator element is disposed as a diaphragm, which is flexurally deformed in accordance with pressure received, it becomes possible to use the MEMS vibrator of JP-A-9-126920 as the pressure sensor. In this case, since the resonant frequency of the vibrator varies in accordance with an amount of deflection of the diaphragm, the pressure can be detected based on the variation in the resonant frequency.

However, in the case of applying the MEMS vibrator of JP-A-9-126920 to such a pressure sensor as described above, the following problem arises. In the MEMS vibrator of JP-A-9-126920, the peripheral structure includes a wall section surrounding the vibrator element and having a hollow section, and a covering section provided to the wall section so as to block an opening of the hollow section. Further, the substrate is formed of a silicon substrate, the wall section is formed of a laminate body of an SiO₂ layer and an aluminum layer, and the covering section is formed of an aluminum layer. Therefore, due to the difference in thermal expansion coefficient between these sections, a thermal distortion occurs in the pressure sensor. The thermal distortion having occurred deforms the diaphragm in an unwanted manner, and thus, the sensitivity is degraded.

### SUMMARY

An advantage of some aspects of the invention is to provide a physical quantity sensor capable of reducing the unwanted deformation of the diaphragm due to the thermal expansion, an altimeter, an electronic apparatus, and a moving object each equipped with the physical quantity sensor.

The invention can be implemented as the following application examples.

### Application Example 1

A physical quantity sensor according to this application example includes a substrate having a diaphragm which can flexurally be deformed, a sensor element disposed on the diaphragm of the substrate, a wall section disposed on the substrate and surrounding the sensor element in a planar view of the substrate, a covering section partially overlapping the sensor element in the planar view of the substrate, and connected to the wall section, and a reinforcement section partially overlapping the covering section in the planar view of the substrate, and including a material lower in thermal expansion coefficient than a constituent material of the covering section.

According to this application example, since the thermal expansion of the covering section can be reduced by the reinforcement section, an unwanted deformation of the diaphragm due to the thermal expansion can be reduced. Further, by disposing the reinforcement section so as to partially overlap the covering section, the weight of the reinforcement section can be decreased, and thus, it is also possible to reduce the flexural deformation of the covering section due to the weight of the reinforcement section.

### Application Example 2

In the physical quantity sensor according to this application example, it is preferable that the reinforcement section includes a material included in one of the wall section and the diaphragm.

According to this application example, the unwanted deformation of the diaphragm due to the thermal expansion can be reduced to a lower level.

### Application Example 3

In the physical quantity sensor according to this application example, it is preferable that the reinforcement section includes silicon.

According to this application example, the reinforcement section can easily be formed.

### Application Example 4

In the physical quantity sensor according to this application example, it is preferable that the reinforcement section includes a part having a lattice-like shape in the planar view of the substrate.

According to this application example, the thermal expansion of the covering section can effectively be reduced while suppressing the weight of the reinforcement section.

### Application Example 5

In the physical quantity sensor according to this application example, it is preferable that the reinforcement section includes a part having a radial shape in the planar view of the substrate.

According to this application example, the thermal expansion of the covering section can effectively be reduced while suppressing the weight of the reinforcement section.

### Application Example 6

In the physical quantity sensor according to this application example, it is preferable that the reinforcement section is disposed on the covering section.

According to this application example, it becomes easy to form the reinforcement section.

### Application Example 7

In the physical quantity sensor according to this application example, it is preferable that the covering section includes a first layer provided with a through hole penetrating in a thickness direction, and a second layer disposed so as to overlap the first layer, and adapted to seal the through hole, and the reinforcement section is disposed so as to overlap the through hole in the planar view of the substrate.

According to this application example, the airtightness of the hollow section can more reliably be ensured.

### Application Example 8

In the physical quantity sensor according to this application example, it is preferable that the reinforcement section is embedded in the covering section.

According to this application example, the thermal expansion of the covering section can be reduced, and at the same time, warpage of the covering section can also be reduced.

### Application Example 9

In the physical quantity sensor according to this application example, it is preferable that the covering section includes a first layer provided with a through hole penetrating in a thickness direction, and a second layer disposed so as to overlap the first layer, and adapted to seal the through hole, and the reinforcement section is disposed between the first layer and the second layer so as to be shifted from the through hole in the planar view of the substrate.

According to this application example, the reinforcement section can be prevented from becoming an obstacle in manufacturing the physical quantity sensor.

### Application Example 10

In the physical quantity sensor according to this application example, it is preferable that the physical quantity sensor is a pressure sensor adapted to detect pressure.

According to this application example, a physical quantity sensor high in convenience is obtained.

### Application Example 11

An altimeter according to this application example of the invention includes the physical quantity sensor according to the application example described above.

According to this application example, the altimeter high in reliability can be obtained.

### Application Example 12

An electronic apparatus according to this application example includes the physical quantity sensor according to the application example described above.

According to this application example, the electronic apparatus high in reliability can be obtained.

### Application Example 13

A moving object according to this application example includes the physical quantity sensor according to the application example described above.

According to this application example, the moving object high in reliability can be obtained.

### BRIEF DESCRIPTION OF THE DRAWINGS

The invention will be described with reference to the accompanying drawings, wherein like numbers reference like elements.

FIG. 1 is a cross-sectional view showing a physical quantity sensor according to a first embodiment of the invention.

FIG. 2 is a plan view showing sensor elements provided to the physical quantity sensor shown in FIG. 1.

FIG. 3 is a diagram for explaining a circuit including the sensor elements shown in FIG. 2.

FIG. 4 is a plan view showing a reinforcement section provided to the physical quantity sensor shown in FIG. 1.

FIG. 5 is a cross-sectional view for explaining a method of manufacturing the physical quantity sensor shown in FIG. 1.

FIG. 6 is a cross-sectional view for explaining the method of manufacturing the physical quantity sensor shown in FIG. 1.

FIG. 7 is a cross-sectional view for explaining the method of manufacturing the physical quantity sensor shown in FIG. 1.

FIG. 8 is a cross-sectional view for explaining the method of manufacturing the physical quantity sensor shown in FIG. 1.

FIG. 9 is a cross-sectional view for explaining the method of manufacturing the physical quantity sensor shown in FIG. 1.

FIG. 10 is a cross-sectional view for explaining the method of manufacturing the physical quantity sensor shown in FIG. 1.

FIG. 11 is a cross-sectional view for explaining the method of manufacturing the physical quantity sensor shown in FIG. 1.

FIG. 12 is a cross-sectional view for explaining the method of manufacturing the physical quantity sensor shown in FIG. 1.

FIG. 13 is a plan view showing a reinforcement section provided to a physical quantity sensor according to a second embodiment of the invention.

FIG. 14 is a cross-sectional view showing a physical quantity sensor according to a third embodiment of the invention.

FIG. 15 is a perspective view showing an example of an altimeter according to an embodiment of the invention.

FIG. 16 is a front view showing an example of an electronic apparatus according to an embodiment of the invention.

FIG. 17 is a perspective view showing an example of a moving object according to an embodiment of the invention.

### DESCRIPTION OF EXEMPLARY EMBODIMENTS

Hereinafter, a physical quantity sensor, an altimeter, an electronic apparatus, and a moving object according to the invention will be explained in detail based on the embodiments shown in the accompanying drawings.

### 1. Physical Quantity Sensor

### First Embodiment

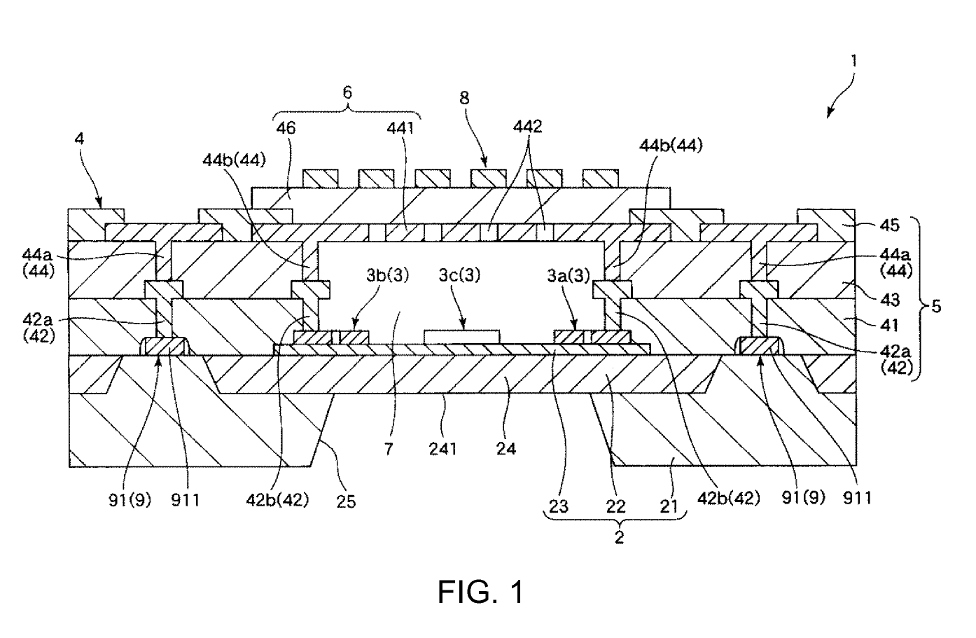

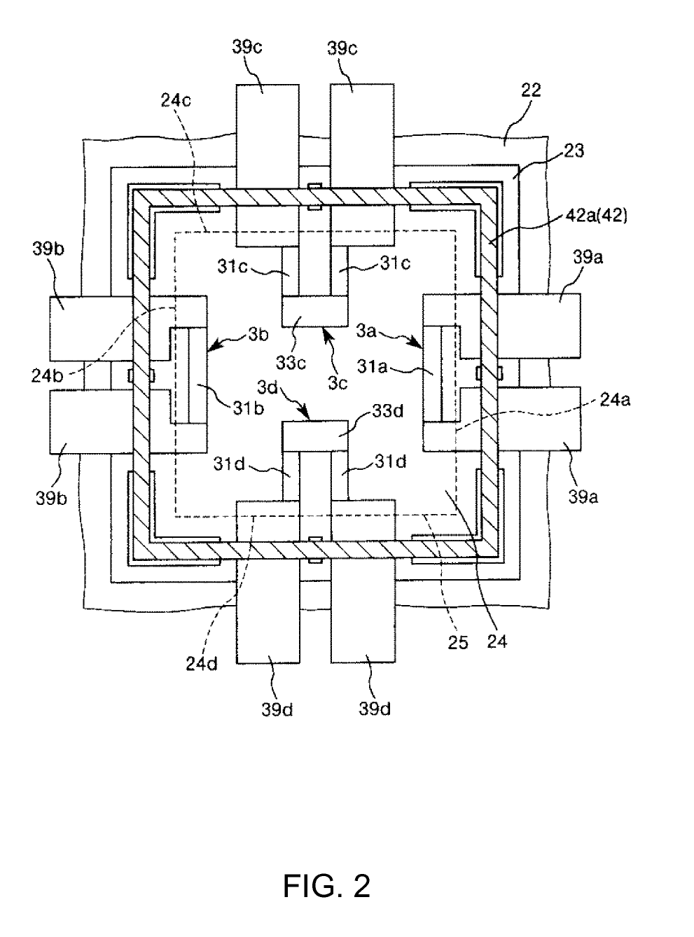

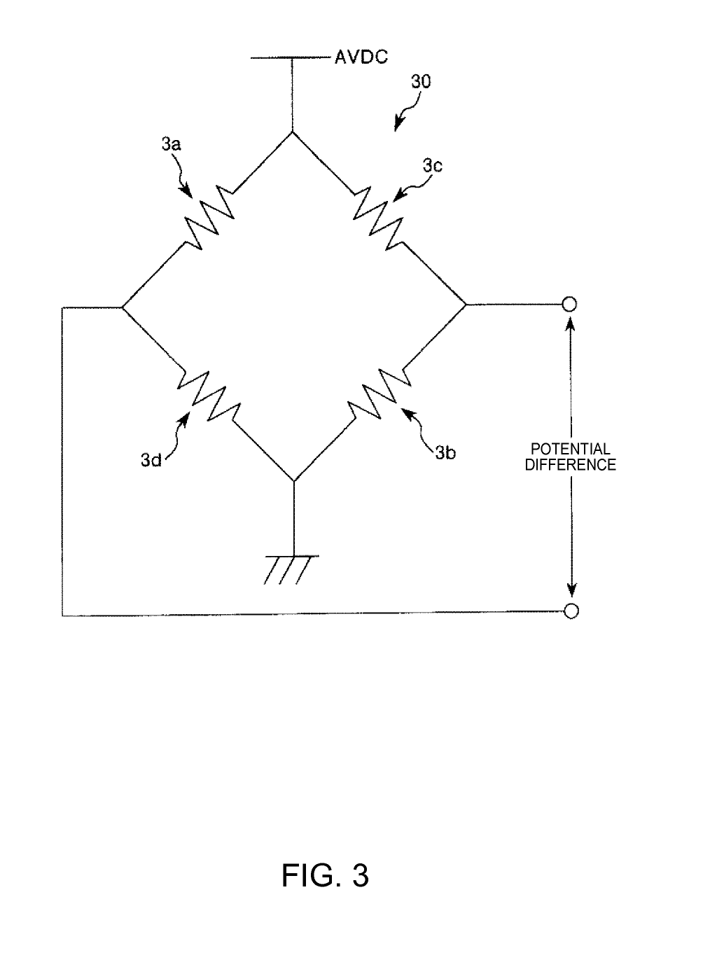

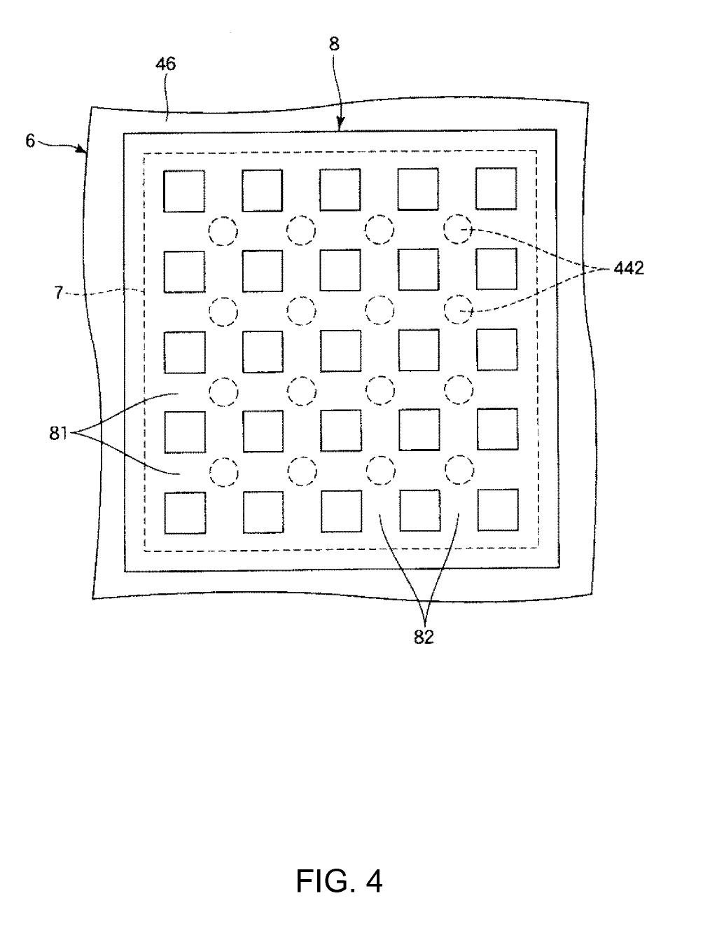

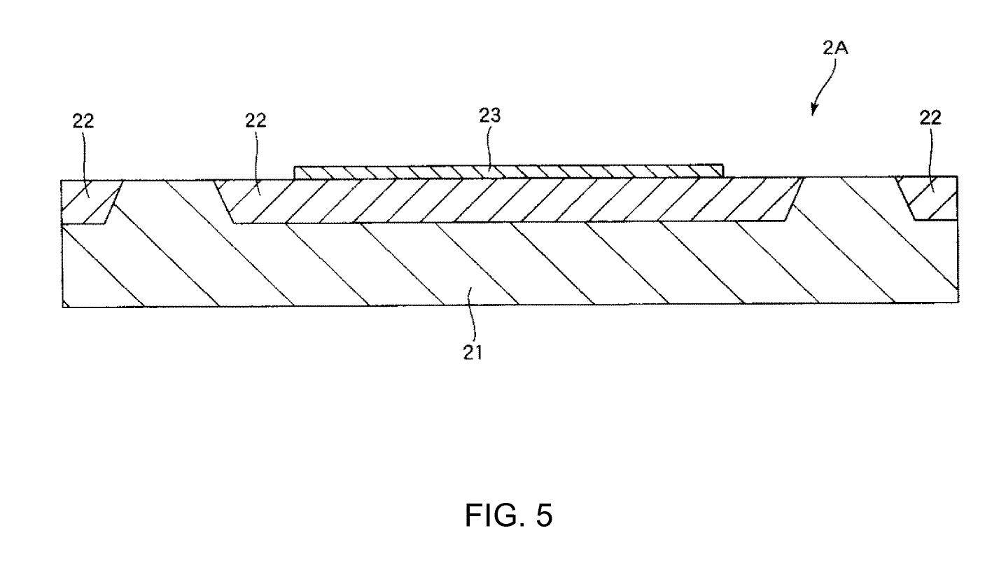

FIG. 1 is a cross-sectional view showing a physical quantity sensor according to a first embodiment of the invention. FIG. 2 is a plan view showing sensor elements provided to the physical quantity sensor shown in FIG. 1. FIG. 3 is a diagram for explaining a circuit including the sensor elements shown in FIG. 2. FIG. 4 is a plan view showing a reinforcement section provided to the physical quantity sensor shown in FIG. 1. FIGS. 5 through 12 are cross-sectional views for explaining a method of manufacturing the physical quantity sensor shown in FIG. 1. It should be noted that the upper side in FIG. 1 is referred to as “upside” and the lower side thereof is referred to as “downside” in the following explanations.

The physical quantity sensor 1 is a pressure sensor capable of detecting pressure. By using the physical quantity sensor 1 as the pressure sensor, a sensor, which can be installed in a variety of electronic apparatuses, can be obtained, and thus, the convenience thereof is enhanced.

As shown in FIG. 1, the physical quantity sensor 1 includes a substrate 2, sensor elements 3, an element peripheral structure 4, a hollow section 7, a reinforcement section 8, and a semiconductor circuit 9.

### Substrate

The substrate 2 has a plate-like shape, and can be formed by stacking a first insulating film 22 formed of a silicon oxide film (SiO₂ film) and a second insulating film formed of a silicon nitride film (SiN film) on a semiconductor substrate 21 formed of a semiconductor such as silicon in this order. It should be noted that the materials of the first insulating film 22 and the second insulating film 23 are not particularly limited providing the semiconductor substrate 21 can be protected in the manufacturing process and the semiconductor substrate 21 and the sensor elements 3 can be isolated from each other.

The planar shape of the substrate 2 is not particularly limited, but can be made to have, for example, a rectangular shape such as a roughly square shape or a roughly oblong shape, or a circular shape, and is made to have a roughly square shape in the present embodiment.

Further, the substrate 2 is provided with a diaphragm 24 thinner in wall thickness than the peripheral portion, and flexurally deformed due to the pressure received. The diaphragm 24 is formed by providing a recessed section 25 with a bottom to a lower surface of the substrate 2, and the lower surface forms a pressure receiving surface (a physical quantity detection surface) 241. The planar shape of such a diaphragm 24 is not particularly limited, but can be made to have, for example, a rectangular shape such as a roughly square shape or a roughly oblong shape, or a circular shape, and is made to have a roughly square shape in the present embodiment. Further, the thickness of the diaphragm 24 is not particularly limited, but can preferably be no smaller than 10 μm and no larger than 50 μm, and more preferably no smaller than 15 μm and no larger than 25 μm. Thus, the diaphragm 24 can sufficiently make the flexural deformation.

Further, although in the substrate 2 of the present embodiment, the recessed section 25 penetrates the semiconductor substrate 21, and the diaphragm 24 is formed of two layers, namely the first insulating film 22 and the second insulating film 23, it is possible to adopt a configuration in which, for example, the recessed section 25 does not penetrate the semiconductor substrate 21, and the diaphragm is formed of three layers, namely the semiconductor substrate 21, the first insulating film 22, and the second insulating film 23.

Further, a semiconductor circuit (a circuit) 9 is built on or above the semiconductor substrate 21. The semiconductor circuit 9 includes circuit elements such as an active element including a MOS transistor 91, a capacitor, an inductor, a resistor, a diode, and a wiring line formed as needed. By building the semiconductor circuit 9 into the substrate 2 in such a manner as described above, miniaturization of the physical quantity sensor 1 can be achieved compared to the case of disposing the semiconductor circuit 9 as a separate body. It should be noted that in FIG. 1, the MOS transistor 91 is shown alone for the sake of convenience of explanation.

### Sensor Elements

As shown in FIG. 2, the sensor elements 3 are formed of a plurality of (four in the present embodiment) piezoresistive elements 3a, 3b, 3c, and 3d disposed on the diaphragm 24 of the substrate 2.

The piezoresistive elements 3a, 3b are disposed so as to correspond to a pair of sides 24a, 24b opposed to each other of the diaphragm 24 having a quadrangular shape in a planar view, and the piezoresistive elements 3c, 3d are disposed so as to correspond to a pair of sides 24c, 24d opposed to each other of the diaphragm 24 having a quadrangular shape in the planar view.

The piezoresistive element 3a has a piezoresistive section 31a disposed in the vicinity (in the vicinity of the side 24a) of an outer peripheral portion of the diaphragm 24. The piezoresistive section 31a has an elongated shape extending along a direction parallel to the side 24a. Wiring lines 39a are respectively connected to both end portions of the piezoresistive section 31a. Similarly, the piezoresistive element 3b has a piezoresistive section 31b disposed in the vicinity (in the vicinity of the side 24b) of an outer peripheral portion of the diaphragm 24. Wiring lines 39b are respectively connected to both end portions of the piezoresistive section 31b.

In contrast, the piezoresistive element 3c includes a pair of piezoresistive sections 31c disposed in the vicinity (in the vicinity of the side 24c) of the outer peripheral portion of the diaphragm 24, and a connection section 33c connecting the pair of piezoresistive sections 31c to each other. The pair of piezoresistive sections 31c are parallel to each other, and each have an elongated shape extending along a direction perpendicular to the side 24c. One end portions (end portions on the center side of the diaphragm 24) of the pair of piezoresistive sections 31c are connected to each other via the connection section 33c, and wiring lines 39c are respectively connected to the other end portions (end portions on the outer periphery side of the diaphragm 24) of the pair of piezoresistive sections 31c. Similarly, the piezoresistive element 3d includes a pair of piezoresistive sections 31d disposed in the vicinity (in the vicinity of the side 24d) of the outer peripheral portion of the diaphragm. 24, and a connection section 33d connecting the pair of piezoresistive sections 31d to each other. One end portions (end portions on the center side of the diaphragm 24) of the pair of piezoresistive sections 31d are connected to each other via the connection section 33d, and wiring lines 39d are respectively connected to the other end portions (end portions on the outer periphery side of the diaphragm 24) of the pair of piezoresistive sections 31d.

Such piezoresistive sections 31a, 31b, 31c, and 31d as described above are each formed of polysilicon (polycrystalline silicon) doped (diffused or injected) with impurity such as phosphorus or boron. Further, the connection sections 33c, 33d of the piezoresistive elements 3c, 3d and the wiring lines 39a, 39b, 39c, and 39d are each formed of polysilicon (polycrystalline silicon) doped (diffused or injected) with impurity such as phosphorus or boron at higher concentration than, for example, that in the piezoresistive sections 31a, 31b, 31c, and 31d. It should be noted that the connection sections 33c, 33d and the wiring lines 39a, 39b, 39c, and 39d can each be formed of metal.

Further, the piezoresistive elements 3a, 3b, 3c, and 3d are configured so as to be equal to each other in resistance value in natural conditions. Further, these piezoresistive elements 3a, 3b, 3c, and 3d are electrically connected to each other via the wiring lines 39a, 39b, 39c, and 39d and so on, and form a bridge circuit 30 (a Wheatstone bridge circuit) as shown in FIG. 3. To the bridge circuit 30, there is connected a drive circuit (not shown) for supplying a drive voltage AVDC. Further, the bridge circuit 30 outputs a signal (voltage) corresponding to the resistance values of the piezoresistive elements 3a, 3b, 3c, and 3d.

Even in the case of using such an extremely thin diaphragm 24 as described above, such sensor elements 3 do not have the problem that the Q-value drops due to the vibration leakage to the diaphragm 24, which arises in the case of using a vibratory element such as a resonator as the sensor element.

### Element Peripheral Structure 4

The element peripheral structure 4 is formed so as to partition the hollow section 7 in which the sensor elements 3 are disposed. The element peripheral structure 4 includes a ring-like wall section 5 formed on the substrate 2 so as to surround the sensor elements 3, and a covering section 6 for blocking the opening of the hollow section 7 surrounded by an inner wall of the wall section 5.

Such an element peripheral structure 4 includes an interlayer insulating film 41, a wiring layer 42 formed on the interlayer insulating film 41, an interlayer insulating film 43 formed on the wiring layer 42 and the interlayer insulating film 41, a wiring layer 44 formed on the interlayer insulating film 43, a surface protecting film 45 formed on the wiring layer 44 and the interlayer insulating film 43, and a sealing layer 46. The wiring layer 44 has a covering layer 441 provided with a plurality of thin holes 442 for making the inside and the outside of the hollow section 7 communicate with each other, and the sealing layer 46 disposed on the covering layer 441 seals the thin holes 442. In such an element peripheral structure 4, the interlayer insulating film 41, the wiring layer 42, the interlayer insulating film 43, the wiring layer (only the part except the covering layer 441), and the surface protecting film 45 constitute the wall section 5 described above, and the covering layer (a first layer) 441 and the sealing layer (a second layer) 46 constitute the covering section 6 described above. The covering section 6 is disposed so as to be connected to the wall section 5, and partially overlaps the sensor elements 3 in a planar view.

It should be noted that the wiring layers 42, 44 respectively include wiring layers 42a, 44a each formed so as to surround the hollow section 7 and wiring layers 42b, 44b constituting wiring lines of the semiconductor circuit 9. Thus, the wiring lines of the semiconductor circuit 9 are drawn to the upper surface of the physical quantity sensor 1 with the wiring layers 42b, 44b.

The interlayer insulating films 41, 43 are not particularly limited, but an insulating film such as a silicon oxide film (SiO₂ film) can be used. Further, the wiring layers 42, 44 are not particularly limited, but a metal film such as an aluminum film can be used. Further, the sealing layer 46 is not particularly limited, but a metal film made of Al, Cu, W, Ti, TiN, or the like can be used. Further, the surface protecting film 45 is not particularly limited, but those having resistance for protecting the element from moisture, dusts, injury, and so on, such as a silicon oxide film, a silicon nitride film, a polyimide film, or an epoxy resin film can be used.

### Hollow Section

The hollow section 7 partitioned by the substrate 2 and the element peripheral structure 4, in other words, the hollow section 7 partitioned by blocking both openings of a hole, which is formed of the inner wall of the wall section 5, with the substrate 2 and the covering section 6, functions as a housing section for housing the sensor elements 3. Further, the hollow section 7 is a closed space. The hollow section 7 functions as a pressure reference chamber used as a reference value for the pressure detected by the physical quantity sensor 1. The hollow section 7 is preferably in a vacuum state (300 Pa or lower), and thus, the physical quantity sensor 1 can be used as an “absolute pressure sensor” for detecting the pressure based on the vacuum state. Therefore, the convenience of the physical quantity sensor 1 is enhanced. It should be noted that the inside of the hollow section 7 is not required to be vacuum, but can be at the atmospheric pressure, in a reduced pressure state with pressure lower than the atmospheric pressure, or in a pressurized state with pressure higher than the atmospheric pressure. Further, an inert gas such as a nitrogen gas or a noble gas can also be encapsulated in the hollow section 7.

### Reinforcement Section

The reinforcement section 8 is disposed on the upper surface of the covering section 6. Further, in the planar view of the physical quantity sensor 1, the reinforcement section 8 is disposed so as to partially overlap the covering section 6. The reinforcement section 8 has a function of reducing the deformation due to the thermal expansion of the covering section 6. Thus, it can be reduced to apply an unwanted thermal stress to the diaphragm 24 to thereby improve the sensitivity of the physical quantity sensor 1. Specifically, in the case of comparing the substrate 2, the wall section 5, and the covering section 6 with each other, the covering section 6 expands at a higher rate than the substrate 2 and the wall section 5 when the temperature rises due to the difference in thermal expansion coefficient between the constituent materials. Then, the stress caused by the thermal expansion of the covering section 6 propagates to the diaphragm 24 to cause the flexural deformation of the diaphragm 24. When the diaphragm 24 is flexurally deformed due to the force (unwanted stress) other than the external pressure as the detection target in such a manner as described above, the sensitivity to the pressure is degraded. Therefore, in the present embodiment, by providing the reinforcement section 8 to reduce the thermal expansion of the covering section 6 to thereby reduce the unwanted stress applied to the diaphragm 24, deterioration in pressure detection sensitivity and variation in sensitivity corresponding to the use temperature (deterioration in temperature characteristics) are reduced.

The reinforcement section 8 having such a function includes a material lower in thermal expansion coefficient than the constituent material of the covering section 6. Therefore, the reinforcement section 8 is more difficult to expand than the covering section 6, and thus the thermal expansion of the covering section 6 is reduced. The material included in the reinforcement section 8 is not particularly limited providing the material is lower in thermal expansion coefficient than the constituent material of the covering section 6, but is preferably a material included in the diaphragm 24. Thus, the degree of the thermal expansion of the reinforcement section 8 can be approximated to the degree of the thermal expansion of the diaphragm 24. In other words, the degree of the thermal expansion of the covering section 6 can be approximated to the degree of the thermal expansion of the diaphragm 24, and thus, the unwanted stress described above to be applied to the diaphragm 24 can effectively be reduced.

In particular, it is preferable for the reinforcement section 8 to include silicon as the constituent material. Specifically, it is preferable for the reinforcement section 8 to be formed of, for example, silicon oxide (SiO₂) or silicon nitride (SiN). By forming the reinforcement section 8 from silicon oxide (SiO₂) or silicon nitride (SiN) as described above, the effect described above can be exerted, and at the same time, the reinforcement section 8 can be formed with relative ease.

As shown in FIG. 4, the reinforcement section 8 has a lattice-like shape as a whole. Specifically, assuming two directions perpendicular to each other in a planar view as first and second directions, the reinforcement section 8 has a configuration in which a plurality of first extending sections 81 extending in the first direction and arranged side by side in the second direction and a plurality of second extending sections 82 extending in the second direction and arranged side by side in the first direction intersect with each other. By adopting such a shape, the thermal expansion of the covering section 6 can effectively be reduced while decreasing the weight of the reinforcement section 8. By decreasing the weight of the reinforcement section 8 as much as possible, the deflection of the covering section 6 due to the weight can be reduced.

It should be noted that the shape of the reinforcement section 8 is not limited to the shape in the present embodiment, but can also be, for example, an irregular shape. Further, a shape including a part of such a lattice-like shape as in the present embodiment as a part of the shape can also be adopted.

Further, the reinforcement section 8 is disposed on the upper surface (outer surface) of the covering section 6. Thus, the reinforcement section 8 can easily be formed. Further, the reinforcement section 8 is disposed so as to overlap the thin holes 442 provided to the covering layer 441 of the covering section 6. Thus, since the thin holes 442 can be sealed not only with the sealing layer 46 but also with the reinforcement section 8, the airtightness (the vacuum state) of the hollow section 7 can more surely be maintained.

The thickness of such a reinforcement section 8 (the first and second extending sections 81, 82) is not particularly limited, but is preferably no lower than ½ times and no higher than 5 times of the covering section 6, for example, and more preferably no lower than 1 times and no higher than 2 times. Thus, the effect described above can effectively be exerted while preventing the physical quantity sensor 1 from growing in size due to excessive increase in thickness of the covering section 6.

Hereinabove, the configuration of the physical quantity sensor 1 is briefly explained.

In the physical quantity sensor 1 having such a configuration, the diaphragm 24 deforms in accordance with the pressure received by the pressure receiving surface 241 of the diaphragm 24, and thus, the piezoresistive elements 3a, 3b, 3c, and 3d are deflected, and thus, the resistance values of the piezoresistive elements 3a, 3b, 3c, and 3d vary in accordance with the deflection amount. In accordance with the variation, the output of the bridge circuit 30 constituted by the piezoresistive elements 3a, 3b, 3c, and 3d varies, and then, the level of the pressure (the absolute pressure) received in the pressure receiving surface 241 can be obtained based on the output. In particular, as described above, since the physical quantity sensor 1 is provided with the reinforcement section 8, the deterioration of the pressure detection sensitivity due to the thermal expansion of each of the sections, and the variation in sensitivity corresponding to the use temperature can be reduced.

In such a physical quantity sensor 1 as described above, since the hollow section 7 and the semiconductor circuit are disposed on the same surface side of the semiconductor substrate 21, the element peripheral structure 4 forming the hollow section 7 does not project from the opposite side of the semiconductor substrate 21 to the semiconductor circuit, and thus, reduction in height can be achieved. On the basis described above, the element peripheral structure 4 is formed in the same deposition process as at least one of the interlayer insulating films 41, 43 and the wiring layers 42, 44. Thus, the element peripheral structure 4 can be formed in a lump with the semiconductor circuit using the CMOS process (in particular a process of forming the interlayer insulating films 41, 43 and the wiring layers 42, 44). Therefore, the manufacturing process of the physical quantity sensor 1 can be simplified, and as a result, cost reduction of the physical quantity sensor 1 can be achieved. Further, even in the case of sealing the hollow section 7 as in the present embodiment, the hollow section 7 can be sealed using a deposition process, and it is not required to seal the cavity by bonding the substrates to each other as in the related art. At this point, the manufacturing process of the physical quantity sensor 1 can be simplified, and as a result, the cost reduction of the physical quantity sensor 1 can be achieved.

Further, since the sensor elements 3 include the piezoresistive elements 3a, 3b, 3c, and 3d, and the sensor elements 3 and the semiconductor circuit are located on the same surface side of the semiconductor substrate 21 as described above, the sensor elements 3 can be formed in a lump with the semiconductor circuit using the CMOS process (in particular the process for forming the MOS transistor 91). Therefore, at this point, the manufacturing process of the physical quantity sensor 1 can further be simplified.

Further, since the sensor elements 3 are disposed on the element peripheral structure 4 side of the diaphragm 24, it is possible to house the sensor elements 3 inside the hollow section 7, and thus, it is possible to prevent the sensor elements 3 from deteriorating, or to reduce the degradation of the characteristics of the sensor elements 3.

Then, a method of manufacturing the physical quantity sensor 1 will briefly be explained.

FIGS. 5 through 12 are diagrams showing a manufacturing process of the physical quantity sensor 1 shown in FIG. 1. The explanation will hereinafter be presented based on these drawings.

### Sensor Element/MOS Transistor Forming Process

Firstly, as shown in FIG. 5, the first insulating film (a silicon oxide film) 22 is formed by thermally oxidizing the upper surface of the semiconductor substrate 21 such as a silicon substrate, and then, the second insulating film (a silicon nitride film) 23 is formed on the first insulating film 22 by a sputtering process, a CVD process, or the like. Thus, the substrate 2A is obtained.

The first insulating film 22 functions as an inter-element separation film in forming the semiconductor circuit 9 on or above the semiconductor substrate 21. Further, the second insulating film 23 has resistance to etching executed in a hollow section forming process performed later, and functions as a so-called etch stop layer. It should be noted that the range in which the second insulating film 23 is formed is limited to a range including a planar range where the sensor elements 3 are formed by a patterning process, and a range of some elements (capacitors) in the semiconductor circuit 9. Thus, the second insulating film 23 is prevented from being an obstacle in forming the semiconductor circuit 9 on or above the semiconductor substrate 21.

Further, although not shown in the drawings, in a part of the upper surface of the semiconductor substrate 21 where neither the first insulating film 22 nor the second insulating film 23 is formed, there is formed a gate insulating film of the MOS transistor 91 by thermal oxidization, and source and drain of the MOS transistor 91 by doping impurity such as phosphorus or boron.

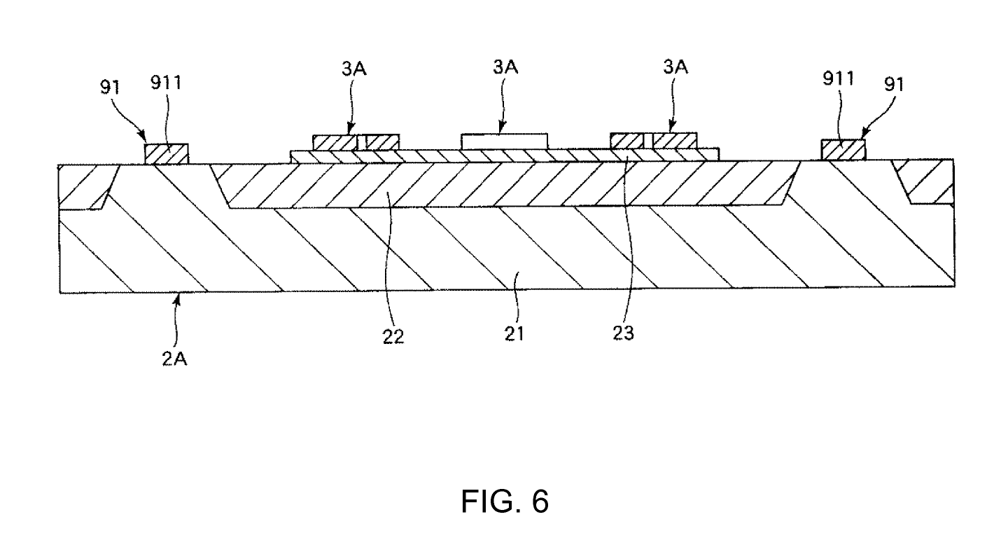

Then, a polycrystalline silicon film (or an amorphous silicon film) is formed on the upper surface of the substrate 2A by a sputtering process, a CVD process, or the like, and then patterning is performed on the polycrystalline silicon film by etching to thereby form an element forming film 3A for forming the sensor elements 3, and a gate electrode 911 of the MOS transistor 91 as shown in FIG. 6.

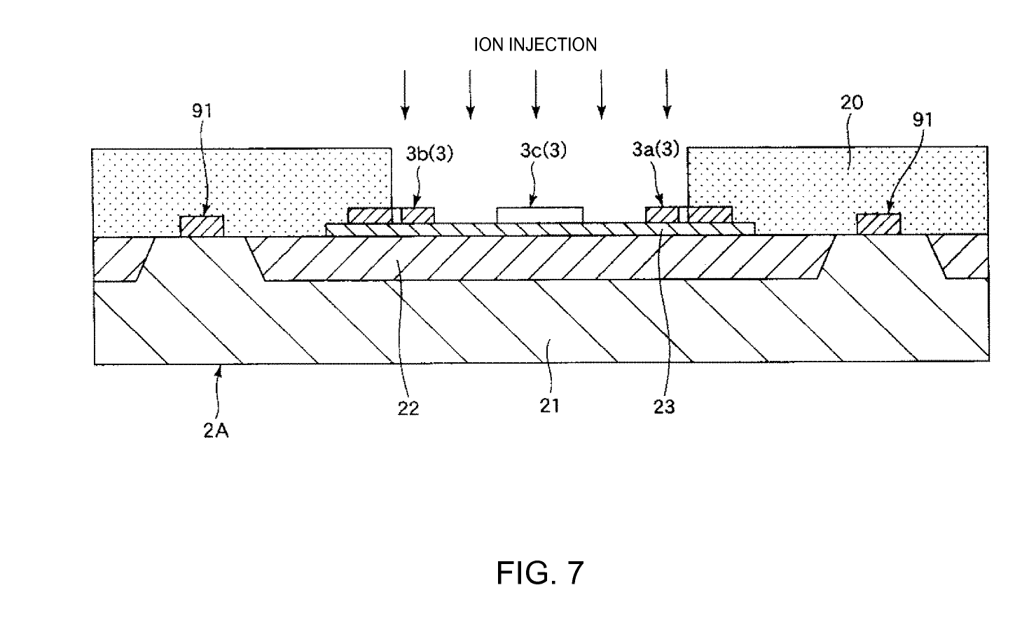

Then, by forming a photoresist film 20 on a part of the upper surface of the substrate 2A so that the element forming film 3A is exposed, and then doping (ion-injecting) the impurity such as phosphorous or boron into the element forming film 3A, the sensor elements 3 are formed as shown in FIG. 7. In the ion-injection process, the shape of the photoresist film 20, ion-injection conditions, and so on are adjusted so that an amount of the impurities doped into the piezoresistive sections 31a, 31b, 31c, and 31d is larger than that of the impurities doped into the connection sections 33c, 33d and the wiring lines 39a, 39b, 39c, and 39d.

### Interlayer Insulating Film/Wiring Layer Forming Process

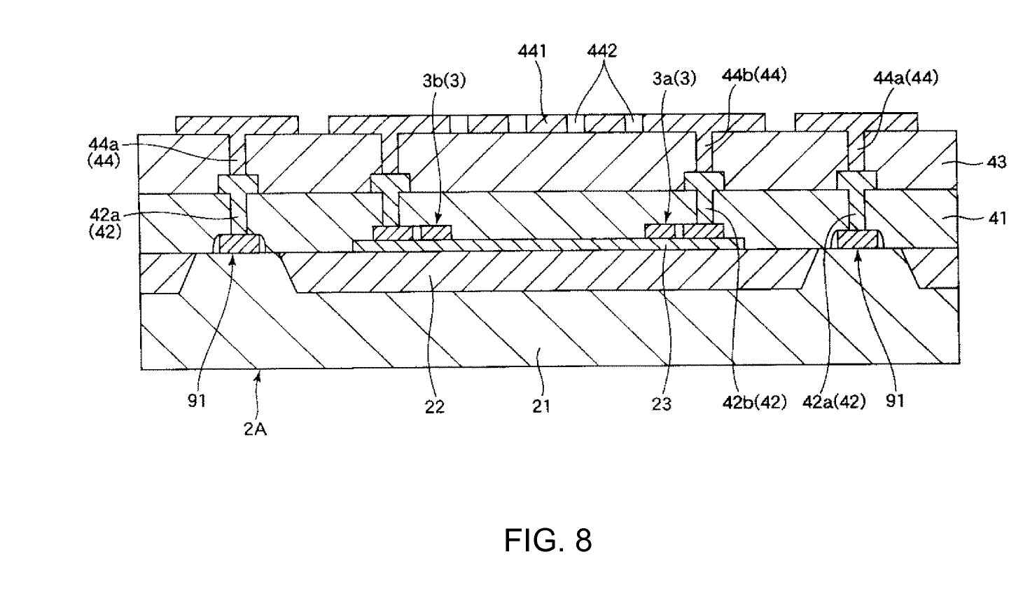

The interlayer insulating films 41, 43 and the wiring layers 42, 44 are formed on the upper surface of the substrate 2A as shown in FIG. 8. Thus, there is obtained a state in which the sensor elements 3, the MOS transistor 91, and so on are covered with the interlayer insulating films 41, 43 and the wiring layers 42, 44.

Formation of the interlayer insulating films 41, 43 is achieved by forming a silicon oxide film using a sputtering process, a CVD process, or the like, and then patterning the silicon oxide film by etching. The thickness of each of the interlayer insulating films 41, 43 is not particularly limited, but is set to be in a range of, for example, no smaller than 1500 nm and no larger than 5000 nm.

Further, formation of the wiring layers 42, 44 is achieved by forming a layer made of, for example, aluminum on the interlayer insulating films 41, 43 using a sputtering process, a CVD process, or the like, and then performing a patterning process. Here, the thickness of each of the wiring layers 42, 44 is not particularly limited, but is set to be in a range of, for example, no smaller than 300 nm and no larger than 900 nm.

Further, the wiring layers 42a, 44a each have a ring-like shape so as to surround the plurality of sensor elements 3 in a planar view. Further, the wiring layers 42b, 44b are electrically connected to the wiring lines (e.g., wiring lines constituting a part of the semiconductor circuit 9) formed on or above the semiconductor substrate 21.

The laminate structure of such interlayer insulating films 41, 43 and such wiring layers 42, 44 is formed using a normal CMOS process, and the number of layers stacked is arbitrarily set as needed. In other words, a larger number of wiring layers are stacked via the interlayer insulating films as needed in some cases.

### Hollow Section Forming Process

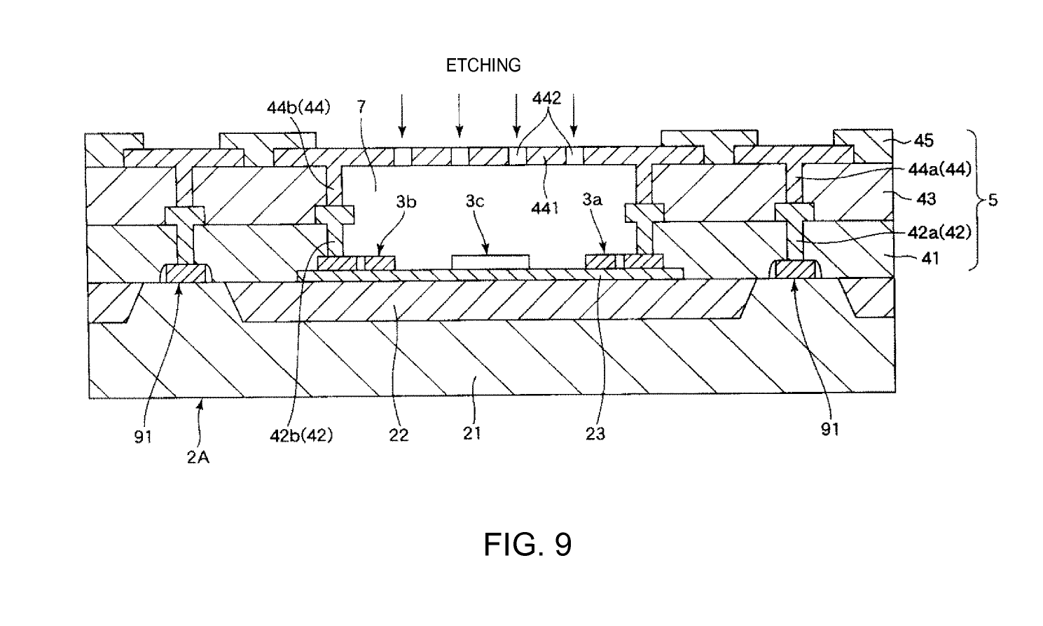

As shown in FIG. 9, after forming the surface protecting film 45 using a sputtering process, a CVD process, or the like, the hollow section 7 is formed by etching. The surface protecting film 45 is constituted by a plurality of film layers including one or more types of material, and is formed so as not to block the thin holes 442 of the covering layer 441. It should be noted that the constituent material of the surface protecting film 45 is not particularly limited, but the surface protecting film 45 is formed of those having resistance for protecting the element from moisture, dusts, injury, and so on, such as a silicon oxide film, a silicon nitride film, a polyimide film, or an epoxy resin film. The thickness of the surface protecting film 45 is not particularly limited, but is set to be in a range of, for example, no smaller than 500 nm and no larger than 2000 nm.

Further, formation of the hollow section 7 is achieved by partially removing the interlayer insulating films 41, 43 by etching through the plurality of thin holes 442 provided to the covering layer 441. Here, in the case of using a wet-etching process as such an etching process, an etching liquid made of hydrofluoric acid, buffered hydrofluoric acid, or the like is supplied through the plurality of thin holes 442, and in the case of using a dry-etching process, an etching gas such as a hydrofluoric acid gas is supplied through the plurality of thin holes 442.

### Sealing Process

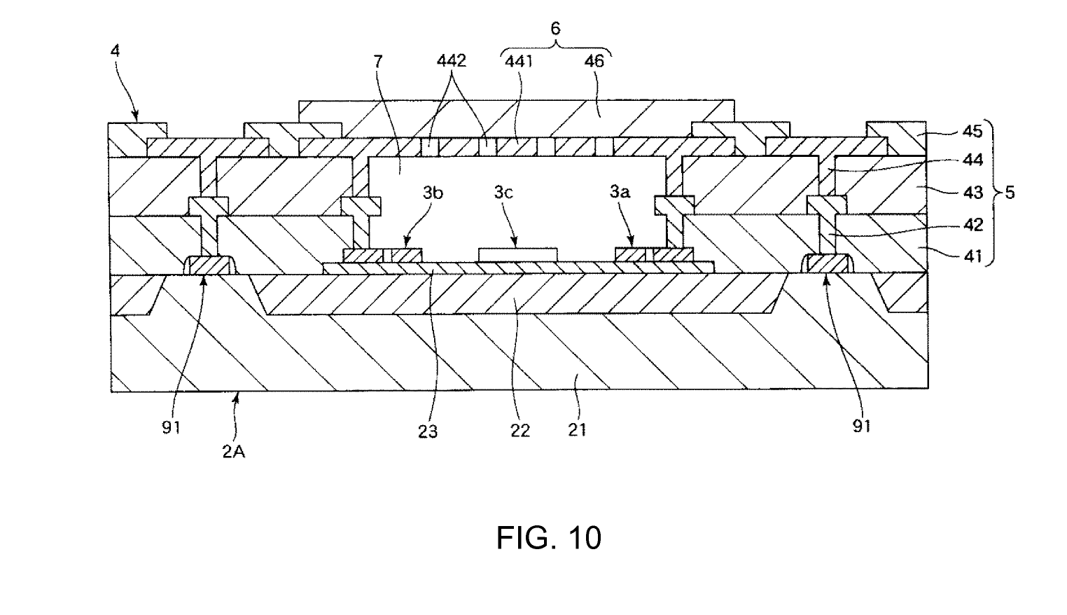

Then, as shown in FIG. 10, the sealing layer 46 formed of a metal film or the like made of Al, Cu, W, Ti, TiN, or the like is formed on the covering layer 441 using a sputtering process, a CVD process, or the like to seal each of the thin holes 442. Thus, the hollow section 7 is sealed with the sealing layer 46, and further, the covering section 6 is formed. The thickness of the sealing layer 46 is not particularly limited, but is set to be in a range of, for example, no smaller than 1000 nm and no larger than 5000 nm.

### Reinforcement Section Forming Process

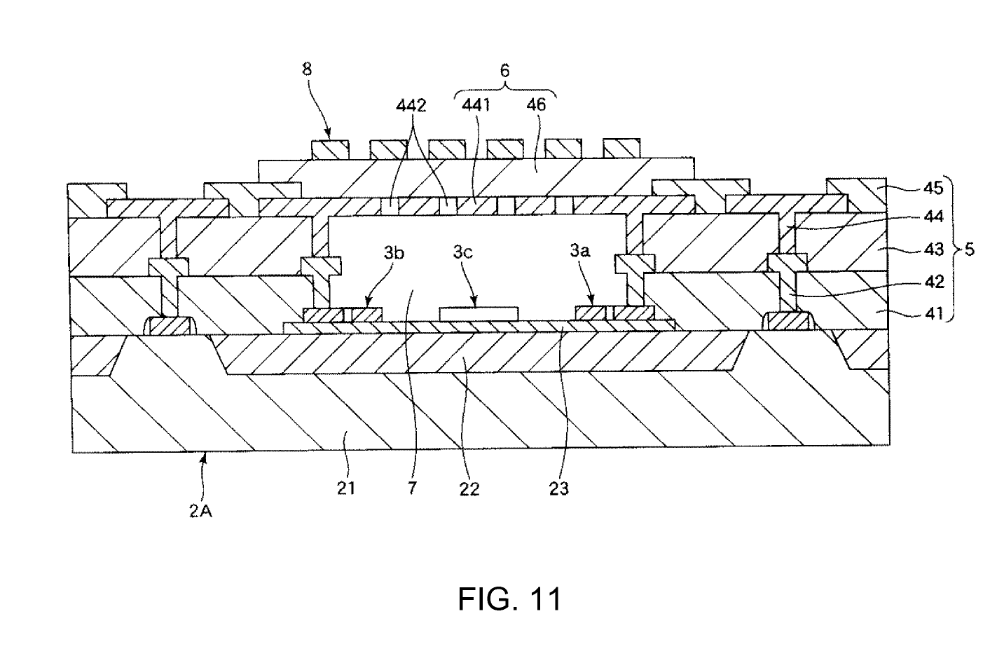

Subsequently, as shown in FIG. 11, the reinforcement section 8 is formed on the upper surface of the covering section 6. Formation of the reinforcement section 8 is achieved by forming a silicon oxide film or a silicon nitride film using a sputtering process, a CVD process, or the like, and then patterning the silicon oxide film or the silicon nitride film by etching.

### Diaphragm Forming Process

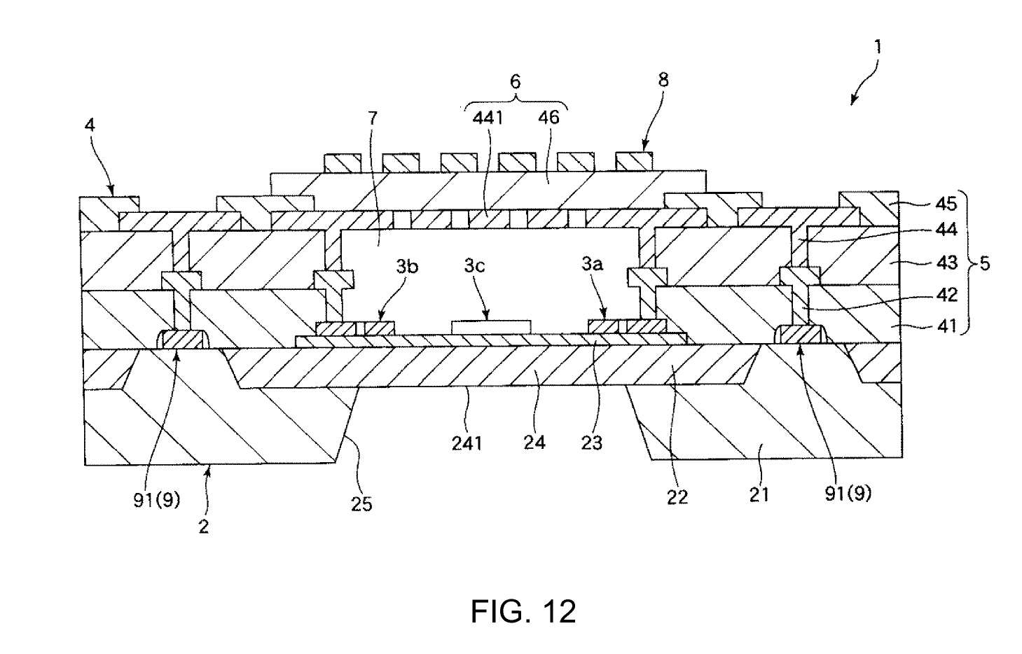

Lastly, a part of the lower surface of the semiconductor substrate 21 is removed by wet etching as shown in FIG. 12. Thus, the physical quantity sensor 1 provided with the diaphragm 24 thinner in wall than the periphery is obtained. It should be noted that the method of removing the part of the lower surface of the semiconductor substrate 21 is not limited to wet etching, but can also be dry etching or the like.

According to the process described hereinabove, the physical quantity sensor 1 can be manufactured. It should be noted that it is possible to build the circuit elements such as an active element other than the MOS transistor, a capacitor, an inductor, a resistor, a diode, or a wiring line included in the semiconductor circuit in the mid-flow of arbitrary processes (e.g., the vibratory element forming process, the insulating film forming process, the covering layer forming process, and the sealing layer forming process) described above. For example, it is possible to form an inter-circuit element separation film together with the first insulating film 22, to form the gate electrode, a capacitance electrode, the wiring lines together with the sensor elements 3, to form a gate insulating film, a capacitance dielectric layer, the interlayer insulating film together with the interlayer insulating films 41, 43, or to form in-circuit wiring lines together with the wiring layers 42, 44.

### Second Embodiment

Then, a physical quantity sensor according to a second embodiment of the invention will be explained.

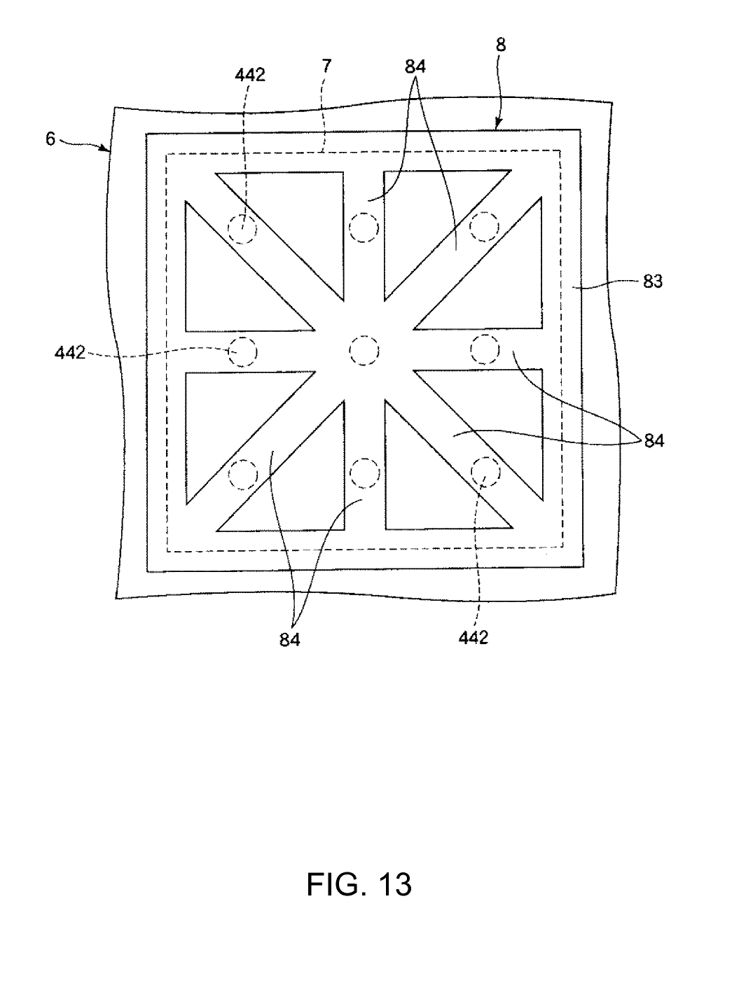

FIG. 13 is a plan view showing a reinforcement section provided to the physical quantity sensor according to the second embodiment of the invention.

Hereinafter, the physical quantity sensor according to the second embodiment of the invention will be explained with a focus mainly on the differences from the embodiment described above, and the explanations regarding similar matters will be omitted.

The second embodiment is substantially the same as the first embodiment described above except the point that the configuration of the reinforcement section is different.

As shown in FIG. 13, the reinforcement section of the present embodiment 8 has a radial shape as a whole. Specifically, the reinforcement section 8 includes a frame section 83 having a frame-like shape arranged along the edge portion of the covering section 6, and a plurality of extending sections 84 radially extending from the center portion of the covering section 6, and having tips connected to the frame section 83. By adopting such a shape, the thermal expansion of the covering section 6 can effectively be reduced. More specifically, the thermal expansion in any direction in an in-plane direction of the covering section 6 can almost evenly be reduced. Further, the weight of the reinforcement section can be decreased. By decreasing the weight of the reinforcement section 8 as much as possible, the deflection of the covering section 6 due to the weight can be reduced.

According also to such a second embodiment as described above, substantially the same advantages as in the first embodiment described above can be obtained.

### Third Embodiment

Then, a physical quantity sensor according to a third embodiment of the invention will be explained.

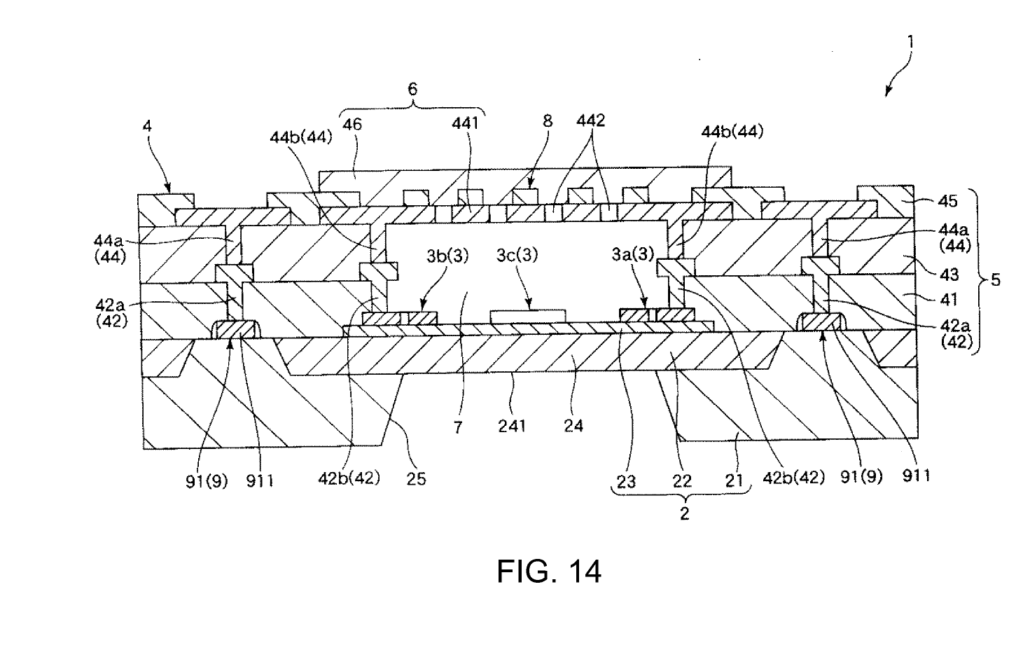

FIG. 14 is a cross-sectional view showing the physical quantity sensor according to the third embodiment of the invention.

Hereinafter, the physical quantity sensor according to the third embodiment of the invention will be explained with a focus mainly on the differences from the embodiment described above, and the explanations regarding similar matters will be omitted.

The third embodiment is substantially the same as the first embodiment described above except the point that the configuration of the reinforcement section is different.

The reinforcement section 8 of the present embodiment is embedded in the covering section 6. Specifically, the reinforcement section 8 is disposed so as to intervene between the covering layer 441 and the sealing layer 46. By embedding the reinforcement section 8 in the covering section 6 in such a manner, the thermal expansion of the covering section 6 can be reduced from the inside of the covering section 6, and therefore, the thermal expansion of the covering section 6 can more effectively be reduced. Further, by embedding the reinforcement section 8 in the covering section 6, the warpage of the covering section 6 in the thermal expansion can be reduced compared to the case of disposing the reinforcement section 8 on either of the principal surfaces as in the first embodiment described above. Therefore, the deterioration of the pressure detection sensitivity due to the thermal expansion of each section and the variation in sensitivity corresponding to the use temperature can effectively be reduced.

Further, the reinforcement section 8 of the present embodiment is formed integrally with the surface protecting film 45. Thus, since it becomes unnecessary to separately provide a process of forming the reinforcement section 8 unlike, for example, the first embodiment described above, simplification of the manufacturing process and reduction in cost of the physical quantity sensor 1 can be achieved.

Here, in the explanation of the method of manufacturing the physical quantity sensor 1 according to the present embodiment, it results that the “Hollow Section Forming Process” in the above description of the first embodiment is performed in the state in which the reinforcement section 8 is formed together with the surface protecting film 45. Therefore, the reinforcement section 8 is disposed so as to be shifted from the thin holes 442 so as not to block the thin holes 442 provided to the covering layer 441, namely so as not to overlap the thin holes 442 in a planar view. Thus, the “Hollow Section Forming Process” can surely be performed. It should be noted that as long as all of the thin holes 442 are not blocked, the reinforcement section 8 can overlap some of the thin holes 442.

According also to such a third embodiment as described above, substantially the same advantages as in the first embodiment described above can be obtained.

### 2. Altimeter

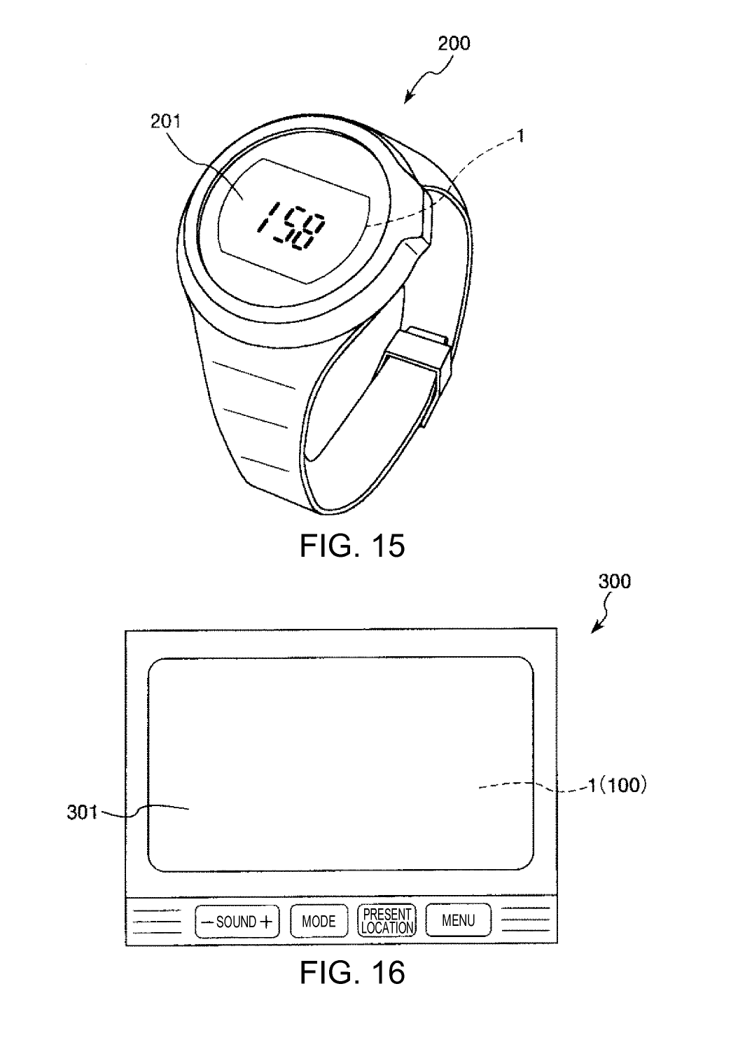

Then, an example of an altimeter equipped with the physical quantity sensor according to an embodiment of the invention will be explained. FIG. 15 is a perspective view showing an example of the altimeter according to the embodiment of the invention.

The altimeter 200 can be mounted on the wrist like a watch. Further, in the inside of the altimeter 200, there is installed the physical quantity sensor 1, and the altitude from the sea level at the present location, the atmospheric pressure at the present location, or the like can be displayed on a display section 201.

It should be noted that a variety of information such as current time, a heart rate of the user, or weather can be displayed on the display section 201.

### 3. Electronic Apparatus

Then, a navigation system to which an electronic apparatus equipped with the physical quantity sensor according to an embodiment of the invention is applied will be explained. FIG. 16 is a front view showing an example of the electronic apparatus according to an embodiment of the invention.

The navigation system 300 is provided with map information not shown, a device for obtaining positional information from the global positioning system (GPS), an autonomous navigation device with a gyro sensor, an acceleration sensor, and vehicle speed data, the physical quantity sensor 1, and a display section 301 for displaying predetermined positional information or course information.

According to this navigation system, the altitude information can be obtained in addition to the positional information obtained. For example, in the case of driving a vehicle on an elevated road shown in roughly the same position in the positional information as an ordinary road without the altitude information, whether the vehicle is running on the ordinary road or on the elevated road cannot be determined with the navigation system, and therefore, the information of the ordinary road is provided to the user as priority information. Therefore, in the navigation system 300 according to the present embodiment, the altitude information can be obtained using the physical quantity sensor 1, and it is possible to detect the change in altitude due to entrance from the ordinary road to the elevated road, and thus, the navigation information in the state of running on the elevated road can be provided to the user.

It should be noted that the display section 301 has a configuration which can be miniaturized and reduced in height, such as a liquid crystal panel display or an organic electro-luminescence (OEL) display.

It should be noted that the electronic apparatus equipped with the physical quantity sensor according to the present embodiment of the invention is not limited to the device described above, but can also be applied to, for example, a personal computer, a cellular phone, a medical instrument (e.g., an electronic thermometer, a blood pressure monitor, a blood glucose monitor, an electrocardiograph, ultrasonic diagnostic equipment, and an electronic endoscope), a variety of measuring instruments, gauges (e.g., gauges for cars, aircrafts, and boats and ships), and a flight simulator.

### 4. Moving Object

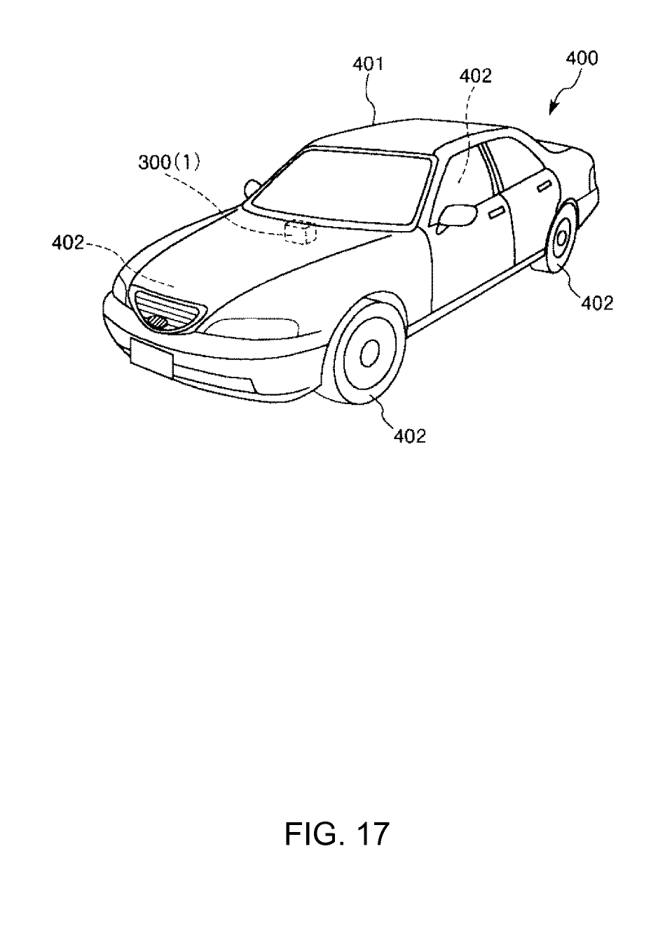

Then, a moving object equipped with the physical quantity sensor according to an embodiment of the invention will be explained. FIG. 17 is a perspective view showing an example of the moving object according to the embodiment of the invention.

As shown in FIG. 17, the moving object 400 has a vehicle body 401, and four wheels 402, and is configured so as to rotate the wheels 402 by a power source (an engine) not shown provided to the vehicle body 401. Such a moving object 400 incorporates the navigation system 300 (the physical quantity sensor 1).

Although the physical quantity sensor, the altimeter, the electronic apparatus, and the moving object according to the embodiments of the invention are described based on the respective embodiments shown in the accompanying drawings as described above, the invention is not limited to these embodiments, but the configuration of each of the components can be replaced with one having an identical function and any configuration. Further, it is possible to add any other constituents or processes.

Further, although in the embodiments described above, the explanation is presented using the case of using the piezoresistive elements as the sensor elements as the example, the invention is not limited to this example, but can use a flap type vibrator, other MEMS vibrators such as interdigital electrode, and a vibratory element such as a crystal vibrator.

Further, although in the embodiments described above, the case of using the four sensor elements is explained as the example, the invention is not limited to this example, but the number of the sensor elements can be no smaller than one and no larger than three, or can be five or more.

The entire disclosure of Japanese Patent Application No. 2014-016647, filed Jan. 31, 2014 is expressly incorporated by reference herein.

What is claimed is:

1. A physical quantity sensor comprising:
a substrate having a diaphragm which can flexurally be deformed;
a sensor element disposed above the diaphragm of the substrate;
a wall section disposed above the substrate and surrounding the sensor element in a planar view of the substrate;
a covering section partially overlapping the sensor element in the planar view of the substrate, and connected to the wall section; and
a reinforcement section partially overlapping the covering section in the planar view of the substrate, and including a material lower in thermal expansion coefficient than a constituent material of the covering section.

2. The physical quantity sensor according to claim 1, wherein
the reinforcement section includes a material included in one of the wall section and the diaphragm.

3. The physical quantity sensor according to claim 1, wherein
the reinforcement section includes silicon.

4. The physical quantity sensor according to claim 1, wherein
the reinforcement section includes a part having a lattice-like shape in the planar view of the substrate.

5. The physical quantity sensor according to claim 1, wherein
the reinforcement section includes apart having a radial shape in the planar view of the substrate.

6. The physical quantity sensor according to claim 1, wherein
the reinforcement section is disposed above the covering section.

7. The physical quantity sensor according to claim 6, wherein
the covering section includes
a first layer provided with a through hole penetrating in a thickness direction, and
a second layer disposed so as to overlap the first layer, and adapted to seal the through hole, and
the reinforcement section is disposed so as to overlap the through hole in the planar view of the substrate.

8. The physical quantity sensor according to claim 1, wherein
the reinforcement section is embedded in the covering section.

9. The physical quantity sensor according to claim 8, wherein
the covering section includes
a first layer provided with a through hole penetrating in a thickness direction, and
a second layer disposed so as to overlap the first layer, and adapted to seal the through hole, and
the reinforcement section is disposed between the first layer and the second layer so as to be shifted from the through hole in the planar view of the substrate.

10. The physical quantity sensor according to claim 1, wherein
the physical quantity sensor is a pressure sensor adapted to detect pressure.

11. An altimeter comprising:
the physical quantity sensor according to claim 1.

12. An electronic apparatus comprising:
the physical quantity sensor according to claim 1.

13. A moving object comprising:
the physical quantity sensor according to claim 1.
